(19) United States
(12) Patent Application Publication
(10) Pub. No.: US 2018/0061534 A1
(43) Pub. Date: Mar. 1, 2018

(54) ADHESIVE POSITIVE TEMPERATURE COEFFICIENT MATERIAL

(71) Applicant: LITTELFUSE, INC., Chicago, IL (US)

(72) Inventors: Chun-Kwan Tsang, Morgan Hill, CA (US); Jianhua Chen, Sunnyvale, CA (US)

(73) Assignee: LITTELFUSE, INC., Chicago, IL (US)

(21) Appl. No.: 15/253,187

(22) Filed: Aug. 31, 2016

(51) Int. Cl. H01C 7/02; H01C 17/00; C08K 3/14; C08K 3/08; C08K 3/04

(52) U.S. Cl. CPC H01C 7/027; H01C 17/00; C08K 3/14; C08K 2201/001; C08K 3/04; C08K 2003/0862; C08K 3/08

(57) ABSTRACT

Positive temperature coefficient (PTC) devices and methods to manufacture PTC devices are disclosed. A PTC device or apparatus may include a grafted polymer. Furthermore, the PTC device may include a conductive filler included in the polymer material. The PTC device may include at least one conductive layer dispose over a surface of the PTC device.

### BACKGROUND

### Field

The present invention relates generally to positive temperature coefficient (PTC) devices and materials, and relates more particularly to PTC materials that have an enhanced adhesive property.

### Description of Related Art

Positive temperature coefficient (PTC) devices are typically utilized in circuits to provide protection against overcurrent conditions. PTC material in the PTC device is selected to have a relatively low resistance within a normal operating temperature range of the PTC device, and a relatively higher resistance above the normal operating temperature range of the PTC device.

For example, a PTC device may be placed in series with a battery terminal so that all the current flowing through the battery flows through the PTC device. The temperature of the PTC device gradually increases as current flowing through the PTC device increases. When the temperature of the PTC device reaches an “activation temperature,” the resistance of the PTC device increases sharply. This in turn significantly reduces the current flow through the PTC device to thereby protect the battery from an overcurrent condition. In another example, a PTC device may be structured as a surface mount resettable fuse. The PTC resettable fuse may have two conductors or leads that couple to a printed circuit board (PCB) or the like. The PTC resettable fuse is designed to protect against damage causable by harmful overcurrent surges and over-temperature faults.

Existing PTC devices normally include a core material having PTC characteristics (i.e., the PTC material). Such PTC devices may be surrounded by a package that comprises a barrier/insulation material. Conductive layers, such as conductive foils, pads or leads, may be electrically coupled to opposite surfaces of the PTC material so that current flows through a cross-section of the PTC material. Existing PTC material adheres poorly to such conductive layers. Therefore, conductive layers including surface nodules or protuberances may be used to enhance mechanical bonding with PTC material. However, conductive layers with surface nodules or protuberances are costly to manufacture. Furthermore, conductive layers with surface nodules or protuberances are generally thicker than conductive layers without surface nodules or protuberances. Therefore, use of conductive layers with surface nodules or protuberances increases the cost of PTC devices, and such conductive layers may undesirably limit manufacturing PTC devices having desired sizes (e.g., small).

Other problems with existing PTC devices will become apparent in view of the disclosure below.

### SUMMARY

This Summary is provided to introduce a selection of concepts in a simplified form further described below in the Detailed Description. This Summary is not intended to identify key or essential features of the claimed subject matter, nor is this Summary intended as an aid in determining the scope of the claimed subject matter.

Positive temperature coefficient (PTC) devices and methods to manufacture PTC devices are disclosed. A PTC device or apparatus may include a polymer material including a grafted polymer. Furthermore, the PTC device may include a conductive filler included in the polymer material. In one implementation, the polymer material includes first and second opposite surfaces. At least one of the first and second opposite surfaces may include a conductive layer that is at least partially disposed over the at least one of the first and second opposite surfaces. The conductive layer may be a metal foil, such as a nickel foil, aluminum foil, or a copper foil.

In another implementation, a method to manufacture a PTC device includes providing a polymer material including a grafted polymer. The method may further include adding a conductive filler to the polymer material, and shaping the polymer material including the conductive filler. The polymer material including the conductive filler may be shaped as a substantially planar layer. The method may further include applying a conductive layer to a surface of the shaped the polymer material including the conductive filler. The conductive layer may be a metal foil, such as a nickel foil, aluminum foil, or a copper foil.

In one implementation, the use of a polymer material including a grafted polymer enhances adhesion of the polymer material to metal, such as a nickel foil, aluminum foil, or a copper foil.

### BRIEF DESCRIPTION OF THE DRAWINGS

FIG. 1 illustrates an implementation of a positive temperature coefficient (PTC) material that may be used in a PTC device;

FIG. 2 illustrates a cross-section view of the PTC material in FIG. 1, as viewed from the perspective of line I-I shown in FIG. 1;

FIG. 3 illustrates another cross-section view of the PTC device, as viewed from the perspective of line I-I shown in FIG. 1;

FIG. 4 illustrates another cross-section view of the PTC device, as viewed from the perspective of line II shown in FIG. 1; and

FIG. 5 illustrates an exemplary set of operations for manufacturing a PTC device.

### DETAILED DESCRIPTION

Positive temperature coefficient (PTC) materials are disclosed herein. Furthermore, methods to provide PTC materials are disclosed herein. Moreover, PTC devices are disclosed herein.

In one implementation, a PTC device or apparatus may include a polymer material including a grafted polymer. Furthermore, the PTC device may include a conductive filler included in the polymer material. In one implementation, the polymer material includes first and second opposite surfaces. At least one of the first and second opposite surfaces may include a conductive layer that is at least partially disposed over the at least one of the first and second opposite surfaces. The conductive layer may be a metal foil, such as a nickel foil, aluminum foil, or a copper foil. The use of a polymer material including a grafted polymer enhances adhesion of the polymer material to metal, such as a nickel foil, aluminum foil, or a copper foil. The polymer material may also include non-grafted polymer(s).

In another implementation, a method to manufacture a PTC device includes providing a polymer material including a grafted polymer. The polymer material may also include non-grafted polymer(s). The method may further include adding a conductive filler to the polymer material, and shaping the polymer material including the conductive filler. The polymer material including the conductive filler may be shaped as a substantially planar layer. The method may further include applying a conductive layer to a surface of the shaped polymer material including the conductive filler. The conductive layer may be a metal foil, such as a nickel foil, aluminum foil, or a copper foil. The use of a polymer material including a grafted polymer enhances adhesion of the polymer material to metal, such as a nickel foil, aluminum foil, or a copper foil.

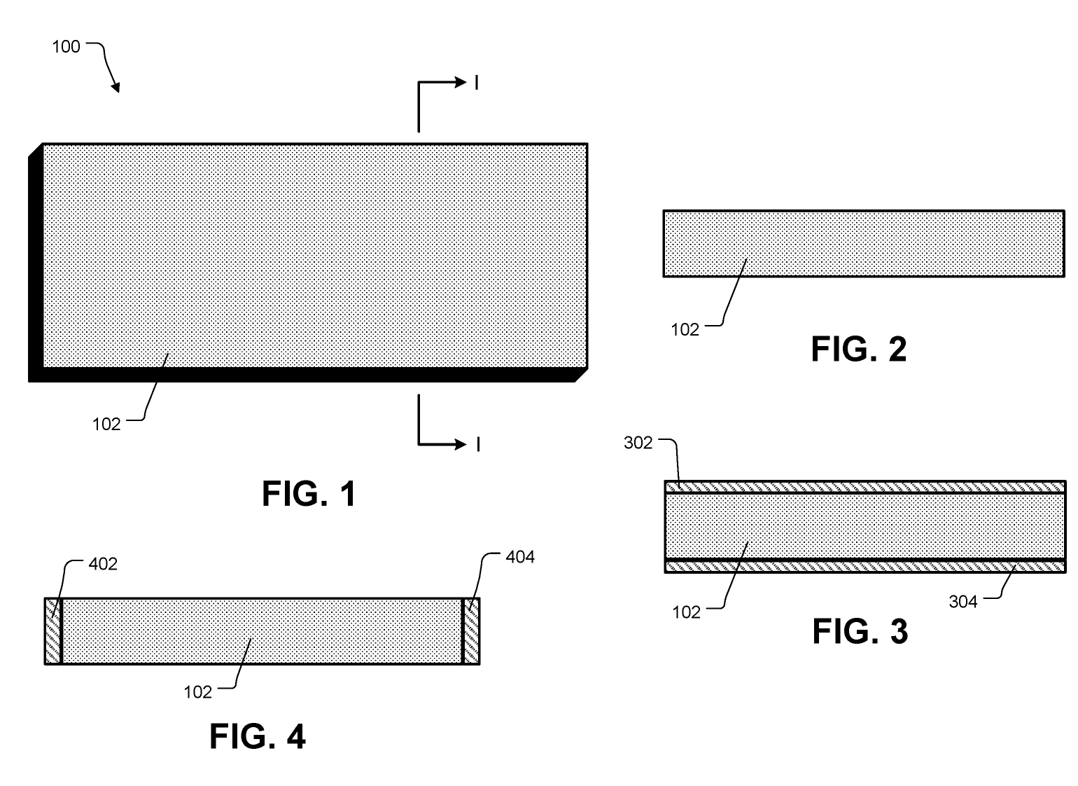

FIG. 1 illustrates an implementation of a PTC device 100. The PTC device 100 includes a PTC material 102. The PTC device 100 illustrated in FIG. 1 is shown as a planar sheet or film including the PTC material 102. However, the PTC device 100 may be provided in other shapes and sizes than that illustrated in FIG. 1.

The PTC material 102 may include one or more conductive, polymer fillers. The conductive filler may include conductive particles of tungsten carbide, nickel, carbon, titanium carbide, or a different conductive filler or different materials having similar conductive characteristics. The polymer filler may include particles of polyvinylidene difluoride, polyethylene, ethylene tetrafluoroethylene, ethylene-vinyl acetate, ethylene butyl acrylate, tetrahydrofuran, tricholorobenzene, dichlorobenzene, dimethylacetamide, dimethyl sulfoxide, cyclohexane, toluene, or different materials having similar characteristics. In general, the PTC material 102 may include a semi-crystalline polymer. Furthermore, the PTC material 100 may comprise a plurality of layers that include unique conductive and polymer fillers.

The PTC material 102 may also include a grafted polymer to enhance adhesion of the PTC material 102 to metal. For example, the use of grafted polymer in the PTC material 102 may enhance adhesion of the PTC material 102 to a metal foil, such as nickel foil, aluminum foil, or copper foil. The PTC material 102 may also include non-grafted polymer(s). In one implementation, the PTC material 102 comprises 5% grafted polymer(s) and 95% non-grafted polymer(s). In another implementation, the PTC material 102 comprises 100% grafted polymer(s) or substantially 100% grafted polymer(s).

In one implementation, the PTC material 102 includes at least maleic anhydride grafted to polymer, the polymer including, for example, at least vinylidene fluoride. In another implementation, the PTC material 102 includes at least maleic anhydride grafted to polymer, the polymer including, for example, at least ethylene vinyl acetate. In yet another implementation, the PTC material 102 includes at least acrylic acid grafted to polymer. In another implementation, the PTC material 102 includes amine grafted to the polymer.

FIG. 2 illustrates a cross-section view of the PTC device 100 in FIG. 1, as viewed from the perspective of line I-I shown in FIG. 1. As illustrated, the PTC device 100 is shaped or formed having a uniform layer. The thickness of the PTC device 100 may be between about 3 μm and 130 μm, for example.

FIG. 3 illustrates another cross-section view of the PTC device 100, as viewed from the perspective of line I-I shown in FIG. 1. In this embodiment, at least one electrically conductive layer 302 is applied over a first surface of the PTC material 102. In the figure, the electrically conductive layer 302 is shown as being in contact with the PTC material 102. However, one or more layers may be disposed between the PTC material 102 and the electrically conductive layer 302. In another embodiment, another electrically conductive layer 304 is applied over a second surface of the PTC material 102. In FIG. 4, the electrically conductive layer 304 is shown as being in contact with the PTC material 102. However, one or more layers may be disposed between the PTC material 102 and the electrically conductive layer 304. In one implementation, one or more of the conductive layers 302 and 304 is a metal. In a particular implementation, one or more of the conductive layers 302 and 304 is a metal foil, such as a nickel foil, aluminum foil, or a copper foil.

FIG. 4 illustrates another cross-section view of the PTC device 100, as viewed from the perspective of line I-I shown in FIG. 1. In this embodiment, at least one electrically conductive layer 402 is applied over a first surface of the PTC material 102. In the figure, the electrically conductive layer 402 is shown as being in contact with the PTC material 102. However, one or more layers may be disposed between the PTC material 102 and the electrically conductive layer 402. In another embodiment, another electrically conductive layer 404 is applied over a second surface of the PTC material 102. In FIG. 4, the electrically conductive layer 404 is shown as being in contact with the PTC material 102. However, one or more layers may be disposed between the PTC material 102 and the electrically conductive layer 404. In one implementation, one or more of the conductive layers 402 and 404 is a metal. In a particular implementation, one or more of the conductive layers 402 and 404 is a metal foil, such as a nickel foil, aluminum foil, or a copper foil.

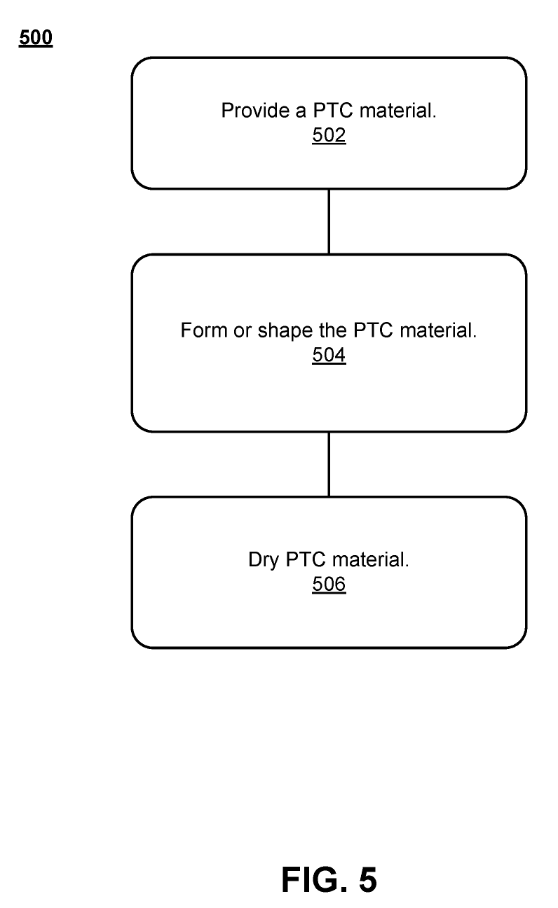

FIG. 5 illustrates an exemplary set of operations for manufacturing a PTC device, such as the PTC device 100 illustrated in FIGS. 1-4. At block 502, a PTC material, such as the PTC material 102 illustrated in FIGS. 1-4, may be provided in a powdered form. Alternatively, the PTC material may be provided in a liquid form, also known as PTC ink. The PTC ink may include a solvent. The solvent may correspond to dimethylformamide, N-Methyl-2-pyrrolidone, tetrahydrofuran, tricholorobenzene, dichlorobenzene, dimethylacetamide, dimethyl sulfoxide, cyclohexane, toluene or a different solvent capable of dissolving the selected polymer matrix. In some implementations, an additive such as an antioxidant, adhesion promoter, anti-arcing material or different additive may be added to improve characteristics of the PTC material, such as polymer stability and/or voltage capability.

The PTC material may include one or more conductive, polymer fillers. The conductive filler may include conductive particles of tungsten carbide, nickel, carbon, titanium carbide, or a different conductive filler or different materials having similar conductive characteristics. The polymer filler may include particles of polyvinylidene difluoride, polyethylene, ethylene tetrafluoroethylene, ethylene-vinyl acetate, ethylene butyl acrylate, tetrahydrofuran, tricholorobenzene, dichlorobenzene, dimethylacetamide, dimethyl sulfoxide, cyclohexane, tolueneor, or different materials having similar characteristics. In general, the PTC material may include a semi-crystalline polymer.

The PTC material may also include a grafted polymer to enhance adhesion of the PTC material to metal. For example, the use of grafted polymer in the PTC material may enhance adhesion of the PTC material to a metal foil, such as nickel foil, aluminum foil, or copper foil.

In one implementation, the PTC material includes at least maleic anhydride grafted to polymer, the polymer including, for example, at least vinylidene fluoride. In another implementation, the PTC material includes at least maleic anhydride grafted to polymer, the polymer including, for example, at least ethylene vinyl acetate. In yet another implementation, the PTC material includes at least acrylic acid grafted to polymer. In another implementation, the PTC material includes amine grafted the polymer.

At block 504, the PTC material is formed or shaped. In one embodiment, the PTC material may be applied to a rigid surface, such as a substrate or a plate. PTC material in powdered form may be sprayed over the rigid surface. PTC material in ink form may also be sprayed over the rigid surface. Alternatively, PTC material in ink form may be applied over the rigid surface using an application blade. PTC material in powdered form may be formed by way of compression using a press or roll press to achieve a desired thickness of the PTC material. Alternatively, the PTC material in powdered form may be melt extruded to achieve a desired thickness of the PTC material. PTC material in ink form may be formed using an application blade (e.g., Doctor Blade) to achieve a desired thickness of the PTC material. In one or more embodiments, the process of forming the PTC material may include providing one or more electrically conductive layers, such as a metal foil, over a surface or surfaces of the PTC material. In one implementation, the PTC material is formed as a sheet having a thickness of about 1 mil. In another implementation, the PTC material is formed as a sheet having a thickness of less than 0.5 mil. Conventionally, ultra-thinly formed PTC material does not retain electrically conductive layers applied to surfaces of the PTC material. The enhanced layer retention capability of the PTC material described herein mitigates the electrically conductive layer retention issues of conventional ultra-thin PTC materials.

At block 506, the PTC material is allowed to harden by drying. In one implementation, the PTC material is hardened in an oven. If solvent is used in the PTC material, the solvent evaporates as the PTC material hardens. The hardened PTC material may provide a PTC device.

While exemplary PTC materials, devices and methods are disclosed, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. Therefore, the claims should not be construed as being limited to any one of the particular embodiments disclosed, but to any embodiments that fall within the scope of the claims.

We claim:

1. An apparatus, comprising:
a polymer material including a grafted polymer; and
a conductive filler included in the polymer material.

2. The apparatus according to claim 1, wherein the conductive filler includes one or more of: metal, metal ceramic, tungsten carbide, nickel, carbon, and titanium carbide.

3. The apparatus according to claim 1, wherein the polymer material includes at least polyvinylidene difluoride, polyethylene, ethylene tetrafluoroethylene, ethylene-vinyl acetate, or ethylene butyl acrylate.

4. The apparatus according to claim 1, wherein the polymer material includes at least a semi-crystalline polymer.

5. The apparatus according to claim 1, wherein the grafted polymer includes at least maleic anhydride grafted to polymer, the polymer including at least vinylidene fluoride.

6. The apparatus according to claim 1, wherein the grafted polymer includes at least maleic anhydride grafted to polymer, the polymer including at least ethylene vinyl acetate.

7. The apparatus according to claim 1, wherein the grafted polymer includes at least acrylic acid grafted to polymer.

8. The apparatus according to claim 1, wherein the grafted polymer includes at least amine grafted to polymer.

9. The apparatus according to claim 1, comprising a conductive layer disposed on a surface of the polymer material.

10. The apparatus according to claim 9, wherein the conductive layer is a metal foil.

11. The apparatus according to claim 10, wherein the metal foil is a nickel foil, aluminum foil, or a copper foil.

12. A method to manufacture a positive temperature coefficient (PTC) device, comprising:
providing a polymer material including a grafted polymer;
adding a conductive filler to the polymer material;
shaping the polymer material including the conductive filler; and
applying a conductive layer to at least a surface of the shaped polymer material.

13. The method according to claim 12, wherein the conductive filler includes one or more of: metal, metal ceramic, carbon tungsten carbide, nickel, carbon, and titanium carbide.

14. The method according to claim 12, wherein the polymer material includes at least polyvinylidene difluoride, polyethylene, ethylene tetrafluoroethylene, ethylene-vinyl acetate, or ethylene butyl acrylate.

15. The method according to claim 12, wherein the grafted polymer includes at least maleic anhydride grafted to polymer, the polymer including at least vinylidene fluoride.

16. The method according to claim 12, wherein the grafted polymer includes at least maleic anhydride grafted to polymer, the polymer including at least ethylene vinyl acetate.

17. The method according to claim 12, wherein the grafted polymer includes at least acrylic acid grafted to polymer.

18. The method according to claim 12, wherein the grafted polymer includes at least amine grafted to polymer.

19. The method according to claim 12, wherein the conductive layer is a metal foil.

20. The method according to claim 19, wherein the metal foil is a nickel foil, an aluminum foil, or a copper foil.
